(19) United States
(12) Patent Application Publication
(10) Pub. No.: US 2014/0328666 A1
(43) Pub. Date: Nov. 6, 2014

(54) Bezentropic Bladeless Turbine

(71) Applicant: Diana Michaels Christopher, Sofia (BG)

(72) Inventor: Van Michaels Christopher, Sofia (BG)

(21) Appl. No.: 14/068,478

(22) Filed: Oct. 31, 2013

Related U.S. Application Data
(63) Continuation-in-part of application No. 13/437,028, filed on Apr. 2, 2012, now abandoned.
Application No. 13/437,028 is a continuation-in-part of application No. 12/214,840, filed on Jun. 24, 2008, now abandoned.

(51) Int. Cl. F01D 1/34; F01D 1/20

(52) U.S. Cl. CPC F01D 1/34; F01D 1/20; F05D 2250/15
USPC 415/1; 415/71

(57) ABSTRACT

A bezentropic bladeless turbine has a bladeless rotor, a bladeless stator, and a CD nozzle that feeds a rectified molecular, supersonic flow of gas and/or steam into the rotor. Spiral channels are provided in the rotor, which serve to maintain and sustain the rectified molecular flow of the working fluid through the rotor. An energy booster device is assembled at the exit of the CD nozzle, to increase the efficiency of the CD nozzle. The rotor is attached to an output shaft, to convert the kinetic energy of the working fluid to mechanical work. Various fluids, such as steam, Freon, wind, may be used as the working fluid.

### BACKGROUND INFORMATION

1. Field of the Invention

The invention relates to the field of power generation by converting a gas to mechanical work. More specifically, the invention relates to improving power generation by kinetically ordering the flow of the gas.

2. Discussion of the Prior Art

It is known to use a de Laval nozzle, also called a convergent-divergent (CD) nozzle, in steam turbines to increase the efficiency. The de Laval nozzle is shaped such, that it accelerates a hot, pressurized gas passing through the convergent phase to a supersonic speed and, upon expansion in the divergent phase, shapes the gas flow so that the heat energy propelling the flow is maximally converted into directed kinetic energy.

It turns out, though, that the de Laval nozzle by itself, when used with the classic turbines, is not a particularly efficient device. The reason for the inefficiency is due to the fact that, although the de Laval nozzle is able to produce a supersonic jet stream of mono directed gas molecules, i.e., kinetically ordered molecules, once this jet stream of kinetically ordered molecules is injected into the classic turbines, nothing maintains and sustains the initial rectification or order, and the potential gain in efficiency is dissipated in entropic losses resulting from the disordered molecular motion of the jet flow that results, as soon as the jet flow encounters the blades of the turbine. The encounter with each successive blade, regardless of any refinements to blade design results in additional entropic losses, thus significantly reducing the efficiency of the conventional turbine.

### BRIEF SUMMARY OF THE INVENTION

The art and novelty of this invention, its disclosure and subsequent claims, is based on the use of two processes and the devices that enable them to produce mechanical work or thrust from gas flow. The first process involves a new use of rectified, mono directional jet stream of gas, steam, or of both, to produce mechanical work or thrust, instead of the conventional use of kinetically disordered molecules of gas, steam, or of both. By “rectification” is meant a kinetically ordered, i.e., mono-directional, flow of the gas molecules. The second process maintains and sustains the rectification process by impeding a reversal into kinetic disorder, prior to producing the desired mechanical work or thrust. This use of molecular rectification involves injecting the kinetically disordered gas, steam, or a combination of both, into the convergent end of de Laval nozzle, or of an oval or flattened nozzle developed by the present inventor, and having a mono-directionally ordered or rectified supersonic jet stream exit from the divergent end of the nozzle. The term “nozzle” as used hereinafter in a description of the inventive methods and apparatuses shall include the de Laval nozzle and the oval or flat nozzle and shall be simply designated a convergent-divergent nozzle, or CD nozzle. The underlying principle of the inventive method is to use the gas flow in this rectified condition, rather than allowing the gas flow to revert to a kinetically disordered flow.

The second inventive process, that of maintaining and sustaining the rectified, mono-directional molecular order, is achieved by injecting the rectified molecules emerging from the divergent end of the CD nozzle into spiral channels of a bladeless bezentropic turbine, which results in a co-linear, cyclic or vortex, i.e., circular, supersonic jet stream of rectified molecules of steam, gas, or a combination of both. This supersonic jet stream is then used as the working body for the production of mechanical work or thrust.

The inventive concept is three-fold. First, the inventive methods apply a rectified, mono-directional and supersonic gas flow to the production of mechanical work or thrust. Second, an inventive process and apparatus are developed that maintain and sustain the rectified gas flow. Third, the inventive apparatus includes a CD nozzle that has an extended divergent end, which, when attached to spiral channels of a bladeless turbine, minimizes entropic losses and therefore results in an extremely efficient conversion of gas flow to work.

The inventive methods and devices are designated “bezentropic” to underscore the use of a molecularly ordered, mono-directional gas flow, in order to distinguish and differentiate them from conventional turbines, which have multitudes of blades, and which rely on kinetically disordered gas or steam as the working body, incurring significant entropic losses. A bezentropic bladeless turbine according to the invention has been built and tested at the Radomir Metals Inc. plant, located in Radomir, Bulgaria.

The bezentropic bladeless turbine relies on spiral channels to maintain and sustain the desired rectified molecular jet flow or stream, as these channels allow an unimpeded flow of the supersonic, rectified molecular jet stream. Once it was realized that this combination of the CD nozzle and spiral channels was so advantageous in reducing entropic losses, it was also possible to devise variations on the bezentropic bladeless turbine, such as, for example, a bezentropic steam turbine, a bezentropic wind turbine, a bezentropic hydraulic Freon turbine, and a bezentropic turbo-compressor.

As stated above, the term bezentropic is used to designate the fact that the inventive methods and apparatus rely on molecular rectification that is maintained and sustained as the working fluid give up its energy, to produce mechanical work or thrust. In contrast, conventional devices work with disordered kinetic gas molecules and rely on volume expansion to produce mechanical work. Several criteria are necessary to achieve the bezentropic effect: the molecularly ordered stream of gas and/or steam has to be emitted from the CD nozzle and the divergent end of the nozzle has to fit a rotor that has spiral channels. These spiral channels provide an unobstructed flowpath for the rectified mono-directional molecular jet stream and help maintain and sustain the velocity of the steam or gas with minimal entropic losses until the flow is spent in the production of mechanical work or thrust.

The bezentropic bladeless turbine according to the invention includes a rotor mounted in a stator, the rotor having spiral channels. The spirals are Archimedean or arithmetic spirals. The CD nozzle is attached directly to the stator, such that the emergent jet stream of molecularly rectified gas and/or steam enters tangentially into the spiral channels of the rotor and evolves into directed, co-linear, cyclic or circular, i.e., vortex, kinetic energy. Calculations indicate that the combination of the rectification process and the use of the CD nozzle attached to the stator as described results in the maintenance and sustenance of the initial rectified mono-directional jet stream without significant entropic losses. As a result, the bezentropic bladeless turbine works is extremely efficient. In essence, the spiral channels in the rotor form a mechanical extension of the divergent end of nozzle, thereby transforming the CD nozzle into a turbine, all the while retaining the nozzle's efficiency. Adding combustion chambers, a compressor, or a steam boiler to the turbine results in a power plant that has the efficiency of the CD nozzle.

### BRIEF DESCRIPTION OF THE DRAWINGS

The present invention is described with reference to the accompanying drawings. In the drawings, like reference numbers indicate identical or functionally similar elements.

FIG. 1A is a front elevation view of a bladeless stator of a bezentropic bladeless turbine according to the invention.

FIG. 1B is a side elevation view of the bladeless stator of FIG. 1.

FIG. 2 is a front elevation view of a rotor with spiral channels.

FIG. 3 illustrates the CD nozzle and energy booster device and rotor.

FIG. 4 illustrates the turbine and the output shaft.

FIG. 5 illustrates two combustion chambers as input devices for the bezentropic bladeless turbine according to the invention.

FIG. 6 illustrates the side wall of the rotor.

FIG. 7 is a steam jet table for the de Laval nozzle for steam jets.

FIG. 8 illustrates the rectification of molecular flow of the working fluid.

FIG. 8A illustrates a flattened shape of the exit opening of the CD nozzle.

FIG. 9 is a schematic illustration of apparatus using wind as the working fluid.

FIG. 10 illustrates the production of hydrogen.

FIG. 11 illustrates the use of Freon as the working fluid.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

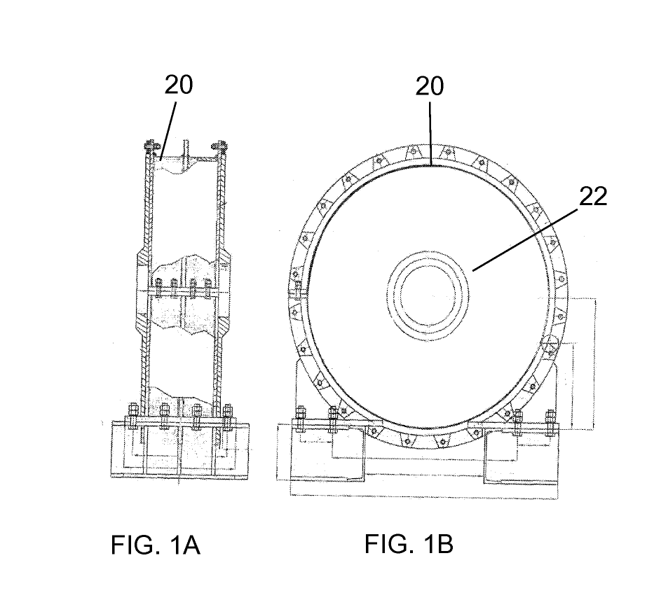

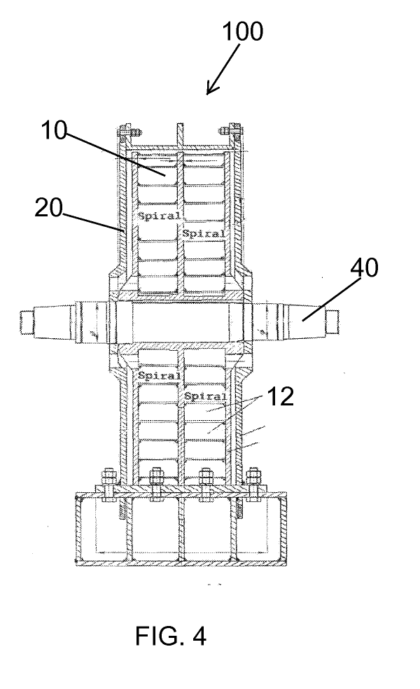

FIGS. 1A, 1B, 2, and 4 illustrate a bezentropic bladeless turbine 100 according to the invention. The bezentropic bladeless turbine 100 comprises a rotor 10 mounted within a stator 20 and a CD nozzle 30 that feeds fluid flow into the rotor 10. The rotor 10 is a bladeless rotor that has, instead of blades, a plurality of spiral channels 12. The fluid that is fed into the rotor is a gas and/or steam and for purposes of simplicity, the term “working fluid” will be used to refer to gas and/or steam. The CD nozzle 30 is a convergent-divergent nozzle, such as a conventional de Laval nozzle or, preferably, a CD nozzle that has a flattened or oval opening at the diverging exit, the flattened opening serving to rectify the initially disordered flow of molecules of the working fluid into an ordered, supersonic flow.

In the embodiment shown in FIGS. 1A and 1B, the bezentropic stator 20 is constructed as an empty horizontal cylinder that houses the rotor 10. The CD nozzle 30 is mounted on the stator 20. Preferably, two CD nozzles 30 are provided on the stator 20, spaced 180 degrees apart. The working fluid is a pressurized combusted gas generated by the combustion chambers and that is fed into the nozzles 30. Apertures 22 are provided in the stator 20 to collect and remove the spent working fluid, which may then be used in a co-generation process.

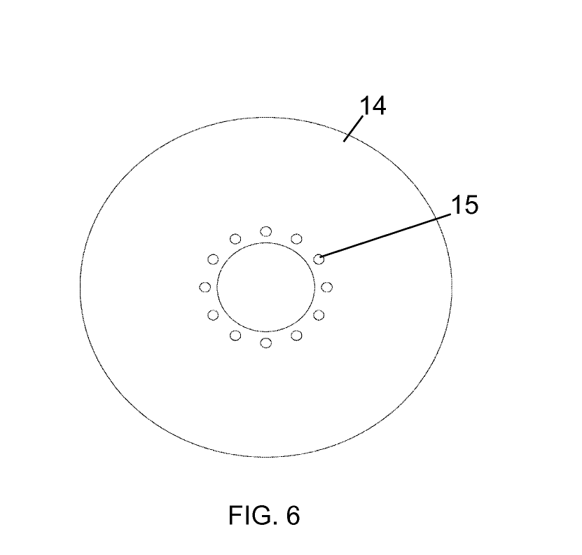

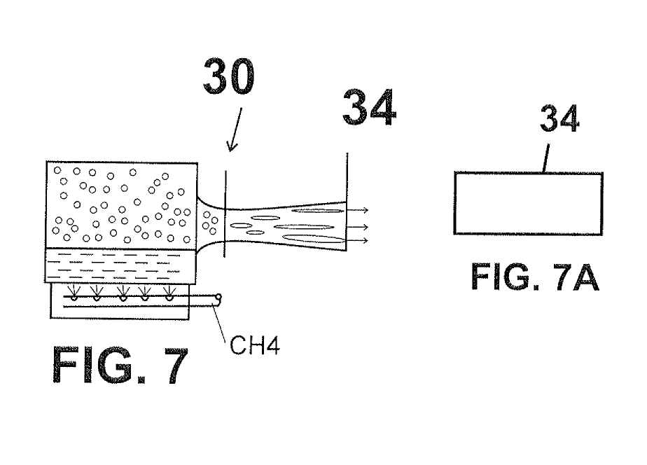

The rotor 10 is constructed to maintain the rectified, co-linear, cyclic or circular (vortex) molecular order of the working fluid that emerges from the nozzle 30 in the form of supersonic jets. The spiral channels 12 in the rotor 10 maintain and sustain the molecular order of the working fluid until the kinetic energy of the working fluid is fully converted into spiral circular kinetic energy that is used to generate mechanical work or thrust. In order to achieve this task, the plurality of blades found in conventional rotors are replaced by two or more opposing, evolving sheet spirals 11 that are attached at both ends to a disk 14, shown in FIG. 6, and are wound around an output shaft 40 as Archimedean or arithmetic spirals. In an Archimedean spiral, the locus of a point corresponds to locations over time of the point moving away from a fixed point with a constant speed along a line that rotates with constant angular velocity. The space between the sheet spirals 11 creates the spiral channels 12. The CD nozzles 30 blow the working fluid with its ordered kinetic energy tangentially toward the spiral channels 12 of the rotor 10. The spent working fluid is evacuated centrally through a series of apertures 15 provided on the disk 14 in an area the output shaft 40, and may be captured for co-generation processes.

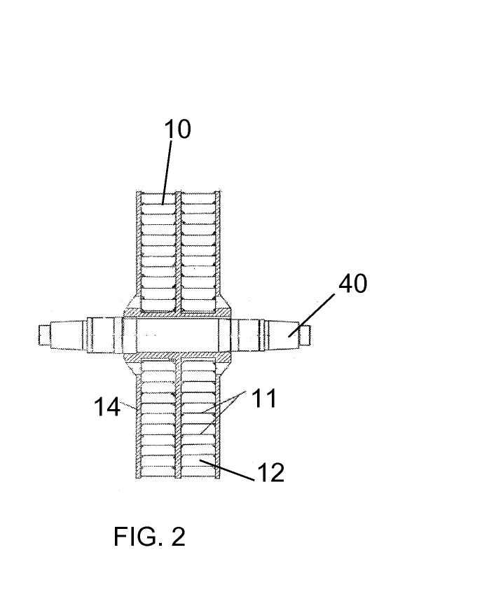

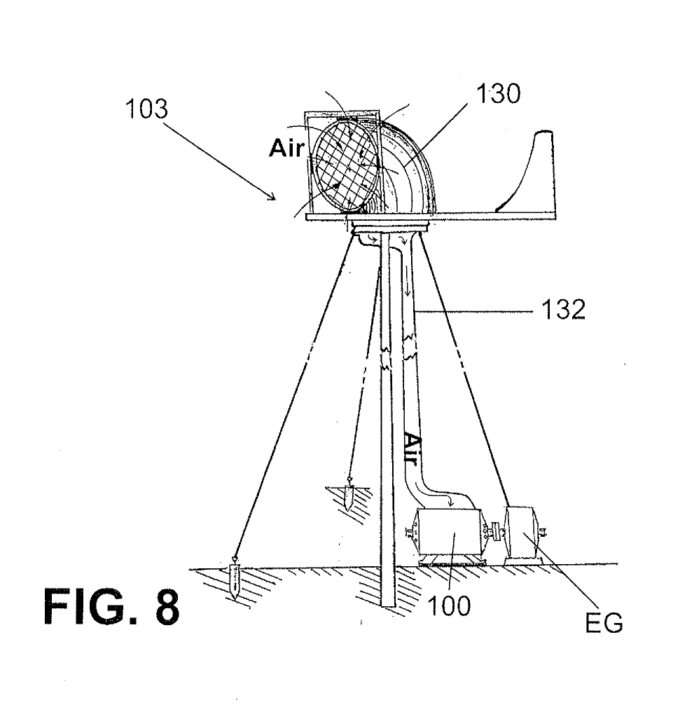

The CD nozzle 30 is shaped to rectify the kinetically disordered molecular flow emitted by the combustion chambers or steam generator, and then to accelerate the working fluid to a supersonic velocity that is then injected into the spiral channels of the rotor 10. The CD nozzle 30 has three main sections 32, 34, and 36. Section 32 is convergent, section 34 divergent, and section 36 is an energy booster device. The divergent section 34 diverges approximately 7 to 12 angular degrees, in order to achieve the supersonic velocity acceleration as is known from the conventional de Laval nozzle. Preferably, an exit opening 34A of the CD nozzle 30 according to the invention, however, has a cross-section that is not circular, but is, instead, flattened to an approximate oval shape, to improve the kinetic ordering of the molecular flow. FIG. 8A illustrates a flattened shape, although it is understood that the “approximate oval” shape includes a shape that is rectangular with rounded corners. In particular, this exit opening 34A is shaped to correspond to the shape of a cross-sectional opening of the spiral channels 12 that receive the supersonically accelerated working fluid. The opening of these spiral channels 12 is generally rectangular in shape, as shown in FIGS. 2, 4, and 5. In a conventional turbine with blades, energy is lost when the gas flow hits the turbine blades, because the rectified molecular flow exiting the CD nozzle is converted into chaotic movement, which entails significant entropic losses. The Archimedean spirals 11 of the rotor 10 according to the invention ensure that the supersonic gas flow exiting the CD nozzle is centered within the spiral channels 12, thereby enabling uninterrupted rectified molecular flow and significantly reducing entropic losses.

Normally, the flattened embodiment of the CD nozzle 30 would be expected to be a little bit less efficient than the round exit of the conventional de Laval nozzle. To overcome this reduction in efficiency, the CD nozzle 30 is used in conjunction with the energy booster device 36, which is a perforated tube, i.e., a dead ended blind-bore tube that is perforated along its length by a series of tiny holes 37. The booster device 36 is affixed parallel to the exit opening 34A of the nozzle 30. Preheated water steam is injected into the energy booster device 36, which is in the space immediately adjacent the exit of the CD nozzle 30. The steam spontaneously flashes into saturated steam, increasing its volume over 1600 times. This added volume additionally accelerates the velocity of the rectified molecular jets as they exit from the CD nozzle 30 and enter the spiral channels 12 to over four times that of sound.

The process according to the invention begins with the injection of the working fluid into the convergent end of the nozzle 30. The working fluid then undergoes a process described by Bernoulli's principle, i.e., the flow increases as the pressure decreases, and emerges from the CD nozzle as a rectified supersonic jet stream of mono-directional molecules. This rectified stream is then injected into the spiral channels 12 of the rotor 10. The stream of working fluid maintains its co-linear, cyclic, or circular (vortex) order throughout its passage through the rotor 10.

The method according to the invention provides a flow of the working fluid that has a rectified kinetic molecular order and maintains and sustains this order as the working fluid emerges from the divergent end 34 of the CD nozzle 30, without impeding the velocity of the working fluid. This reduces the entropic loss to an absolute minimum. The aforementioned spiral channels 12 form the necessary pathways for the rectified supersonic molecular jet stream to flow, which causes the rotor 10 to rotate. The rotor 10 is attached to the output shaft 40, which converts the rotational motion of the rotor into mechanical work or thrust.

The use of the CD nozzle 30 and the spiral channels 12 results in a mechanical extension of the divergent end of the nozzle 30, all the while retaining its capacities and efficiency. Variations of the bezentropic bladeless turbine 100 according to the invention have been developed, based on the preferred modes of energy to be used as the working fluid. The use of the bezentropic bladeless turbine 100 in conjunction with combustion chambers, compressors, or a steam generator, greatly increases the efficiency in the generation of mechanical work or thrust, such as, for example, in the generation of electrical power.

The bezentropic bladeless turbine 100 may be adapted to accommodate preferred alternative energy sources. As such, the bezentropic bladeless turbine 100 may be combined with a water or Freon steam boiler to convert steam to work, or modified to capture wind energy. Other alternative energy sources, such as combustion chambers working on hydrogen or non-pollutant fuel alloys, may be used to generate the working fluid.

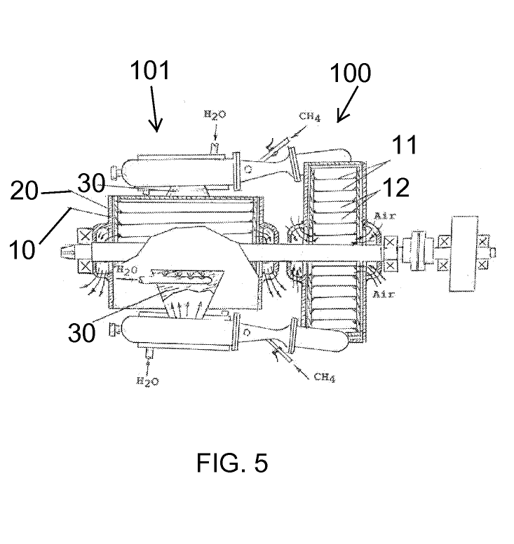

FIG. 5 is a schematic illustration of a bezentropic turbo-compressor 101, used with the bezentropic bladeless turbine 100. The rotor 10 and stator 20 of the compressor are the same as those of the bezentropic bladeless turbine 100, but with a greater diameter, and instead of having combustion chambers, the compressor 101 is connected by two wide tubes to two CD nozzles 30, which are, in turn, connected to two combustion chambers. The two CD nozzles 30 create a strong dynamic pressure, and, thus, act as a check valve that counteracts the static pressure inside the combustion chambers.

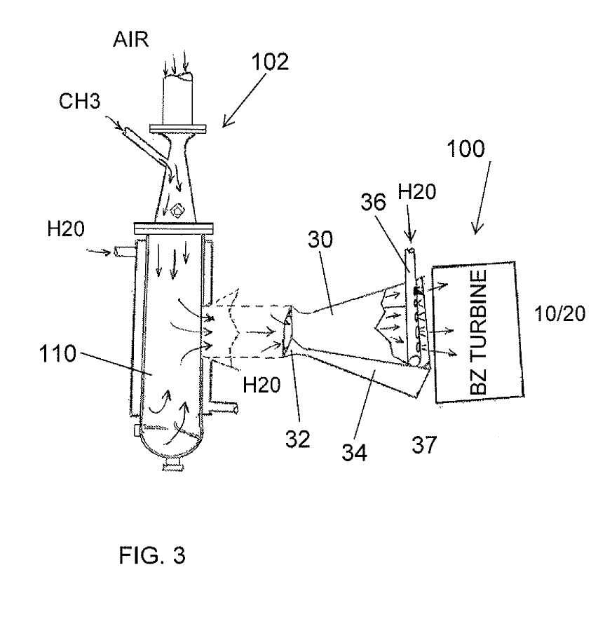

FIG. 3 is a schematic illustration of a bezentropic steam turbine 102 that uses the stator 20 and the rotor 10 previously described. A 20 to 30 atmospheric pressure is required when firing the steam generator 110, in order for the turbine 102 to begin work. Conventional steam generators may be used to generate the working fluid, or alternatively, wind power or a Freon steam generator, which are described below.

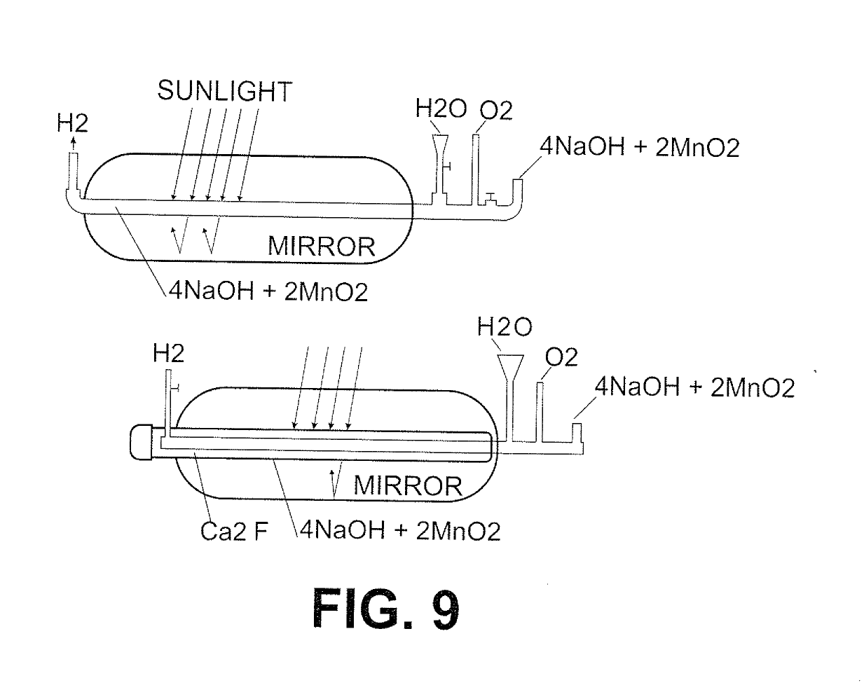

FIG. 9 is a schematic illustration of a bezentropic wind turbine 103, which resembles the steam turbine 102, in that it uses the same cylindrical stator 20 and the rotor 10 with the two or more spiral channels 12. Wind is captured by a large sac-like vessel 130 that is open to the wind. Ideally, the wind vessel 130 is elevated 50 to 100 meters above the ground, on a wind flow conduit 132. The wind flow is piped down through the conduit 132 and replaces the conventional steam generator for generating the working fluid. The wind flow forces the bezentropic bladeless turbine 100 to rotate, and the mechanical work is then connected to an electric generator, as is well known to do in the field of power generation.

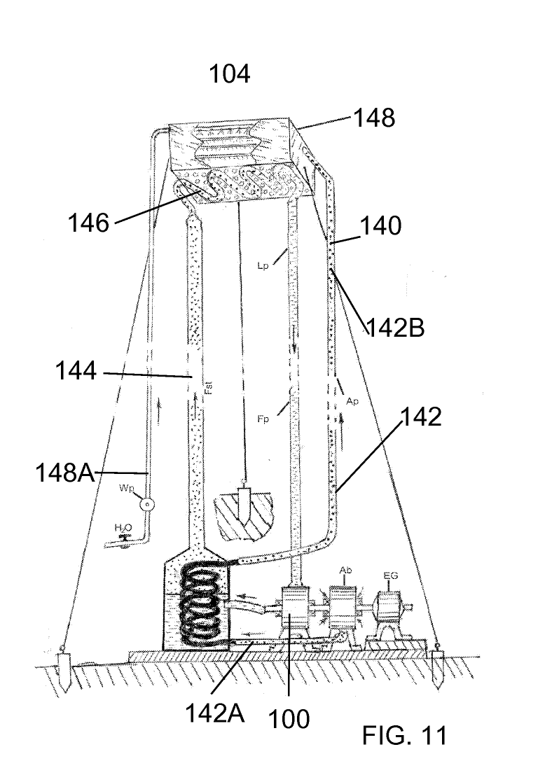

FIG. 11 illustrates a hydraulic Freon steam turbine 104. Freon is well suited to generate steam, because new eco-friendly Freon has a boiling temperature of about −48 to −50 degrees C. Consequently, a temperature of only +50 C to +100 degrees C. is sufficient to produce the desired pressure of 20 to 30 atmospheres of preheated Freon steam. The Freon steam generator 104 has no combustion chamber, but rather, a closed circuit conduit system 140 with a Freon boiler made of a serpentine conduit 142. The hot end of a vortex tube 142A, attached to a suitable compressor Ab, is used to heat the serpentine conduit 142. Once the Freon is heated, it evaporates within a tube 144 and is conducted to a cooling element 143. A water cooler 148, connected to a water line 148A, supplies water. Air is supplied to speed up condensation of the Freon. The Freon in turn is cooled by the cold end of the vortex tube 142B. As precipitation takes place, the Freon falls, thereby turning the rotor 10 in the bezentropic bladeless turbine 100, which is connected to the compressor Ab and a generator EG.

A closed circuit conduit elevation of 100 to 200 meters is required to create the potential energy from the latent heat of vaporization. As the Freon steam reaches the cooling element and is condensed, the Freon precipitates down through the closed circuit conduit, converting the potential energy to kinetic energy, and causing both the compressor Ab and the electric generator EG to rotate. The Freon steam turbine 104 uses as its primary source of energy the latent heat of the vaporization, obtained from the heat of the atmospheric air that is drawn in from the air blower Ab. Compared with the conventional waterfall hydraulic turbine, the Freon steam turbine 14 is much more efficient and effective, because Freon precipitation is about 18 times more quickly created than that of natural waterfalls: the latent heat of vaporization of Freon is only about 32 Kcal/kg, while that of water is about 600 Kcals/kg, both water and Freon being at ambient temperature. As a result, Freon generates roughly 18 more cycles of evaporation, condensation and Freon falls at ambient temperature, as opposed to water at its boiling temperature of 100 degrees C. These parameters make the new eco-friendly Freons extremely attractive for the construction of bezentropic hydraulic electrical power plants.

A method of manufacturing safety (quiet) hydrogen according to the invention comprises several steps. The first one is a redox (Reduction+Oxidation) step, obtained by conducting a first reaction yielding sodium manganate Na2Mn04, a dark green rocky substance, in the absence of air and adding to the reaction talc (hydrated magnesium silicate) 3MgO.4Si02.H2O, to facilitate hydrolysis of the thus obtained rocky sodium manganate. The hydrolysis reverts back the initial reactants, the sodium hydroxide (NaOH) and the pyrolusite (Mn02), needed to begin a new round of the process. The first reaction at 250+degrees C. produces hydrogen, while the second produces oxygen as follows:

4NaOH+2Mn02+talcum 250 C+25 C 2Na2Mn04+talcum (1)

2Na2Mn04+2H20+talcum 4NaOH+2Mn02+O2+talcum

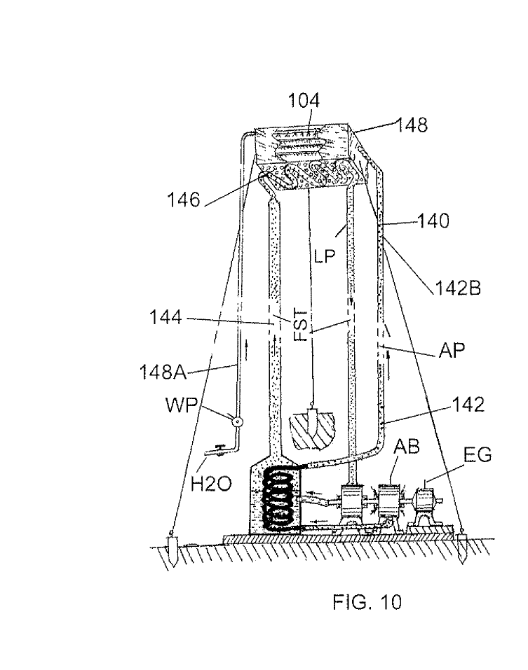

The temperature required to fuse the NaOH is relatively low and, because of this, the reaction may be conducted with sunlight, as shown in FIG. 10. The setup includes a cylindrical mirror in the shape of half silvered and an inflated transparent cylinder, with the transparent side facing the sunlight. The cylinder may be made of plastic or other suitable transparent material. A heat-resistant transparent tube, made of quartz, Pyrex, or any other suitable material, is affixed along the axes of the cylinder. The tube is initially filled up with the necessary mixture of 4NaOH and 2Mn02. Sunlight is concentrated by the cylindrical mirror and raises the temperature of the mixture to a temperature necessary to initiate the first reaction, thereby producing the desired hydrogen, which is then evacuated. It is important to keep the tube for the first reaction out of air or oxygen, for otherwise, instead of hydrogen, the first reaction will produce water steam. Water is introduced to initiate the second reaction. This second reaction occurs at practically any temperature. The thus obtained oxygen is evacuated.

The reactor tube may be removed from the cylindrical mirror at night time or on cloudy days and be heated by the stored heat in granulated CaF2, calcium fluoride. In a heat storage device of the same construction as device shown in FIG. 10, the only difference being that when the device is used for storing heat, the reactor tube should be filled up with CaF2, in order to capture the heat from the available sunlight.

Acetals and hemi acetals may be derived from methane or methane hydrates and used as an alternative energy source for the working fluid. Methane and methane hydrates are abundant in the seas, such as the Black Sea and the world's oceans. The derivation takes place in a reactor comprising four sections, designated sections A, B, C and D, and works by catalytic partial oxidation in the presence of insufficient air or oxygen, performed in section A. There the used catalyst, 1, comprises 99.99% pure electrolytic copper. The temperature required for the derivation is 440.degrees C., plus or minus 20 degrees. To avoid the necessity of using large reactors, the pressure is within a range from atmospheric to no more than 40 atmospheres. The continuous catalytic partial oxidation yields a flow of intermediary synthesis blend of aldehydes, alcohols and a negligent amount of ketons. The amounts, in descending rates, are formaldehyde followed by acetaldehyde, methanol, and some ethanol. Adding propane, butane or, preferably, the hydrocarbons disclosed in U.S. Pat. No. 4,110,082 to the feed stock increases the amounts of the acetaldehyde and the ethanol. Propanal, buthanal, isopropyl, and butyl alcohols appear in small amounts, but, in general, the amounts of the aldehydes formed are twice those of the alcohols.

The catalytic oxidation is exothermic, so, section A of the reactor must be carefully cooled by circulating water inside a copper serpentine conduit, constructed of 99.99% pure electrolytic copper, as is the catalyst, to maintain the required temperature interval of the reaction stable. The catalyst may be provided as copper sponge or spiral copper wire.

It is not necessary to separate the products of the catalytic oxidation, because such a mixture produces a bouquet of acetals, which perform better as fuel and as anti-knocks than do single acetals. The duration of the oxidation process lasts only about 0.4 seconds.

The thusly obtained bouquet of aldehydes and alcohols is then passed into the second section B of the reactor, using a second zeolite catalyst doped by CaCl2. The blend, obtained from the partial oxidation, is then sprinkled with water, to absorb and cool the aldehydes and alcohol blend down to about 50 degrees C. Under the influence of the catalyst, the bouquet of the desired fuel acetals then appears, dissolved in the water having boiling temperatures from 44 degrees C. to 150 degrees C.

Then, in order to have summer acetal fuel, the fraction between 44 degrees C. and 89 degrees C. is first distilled, while the rest is distilled as winter acetal fuel. The distillation proceeds in section C of the reactor, and then in a separate distiller, a second distillation is performed, because the formaldehyde intermediary feed stock contains around 60% water which cannot be eliminated by one distillation. Such a problem does not exist, when, instead of formaldehyde, acetaldehyde is used, because it does not contain water.

Given that section A of the tubular chemical reactor produces twice as much aldehydes as alcohols, half of the obtained aldehyes stay unreacted. To avoid such a loss, half of them are passed inside section D of the chemical reactor, where they are hydrogenated to their corresponding alcohols, and then blended with the other half, inside section B, to be converted into additional acetal fuels.

In a search for clean fuel diversity, the inventor modified the mobile oil process, which converts methanol into light gasoline consisting mainly of hexane. The said complete modification includes replacing the methanol with the said unreacted extra aldehyde blend of the partial oxidation in the reactor, by passing that extra blend through the catalyst ZSM-5. A similar light gasoline is obtained which, again, comprises mainly hexane. The hexane however evolves more CO2 plus some other small pollutants. It is of a lower octane number than the acetal fuels. However, given that hexane is less polluting than the other forms of gasoline, it makes sense to use it for the manufacture of additional acetal fuels.

The chemical formulae of the partial catalytic oxidation and of the synthesis of acetal fuels are: the partial catalytic oxidation of methane yields: aldehydes, alcohols and some ketons (mainly acetone) or:

mCH4+m/nO2 450 C.+−0.25 C 2p+p[CH3CHO+C2H5OH]+Cu(99.99%)+p/q[R1CHO+R1OH+ketons] Equation 1:

Similar reaction may be performed with any other hydrocarbon, even with crude oil, but is not preferable, since this introduces carcinogenic cyclic hydrocarbons and dioxin formed during such fuel combustion.

The following formulae of the synthesis steps are related to the catalytic conversion of the above intermediary product to acetals. In order to achieve them, the vapor phase of the said intermediary products is sprinkled with water to absorb the aldehydes and convert them to liquid phase, because dry (gaseous) form aldehydes do no react with the alcohols. The said liquid phase is then blended with a powdered zeolite catalyst doped with CaCl2 and passed to section B of the reactor. The following reactions produce first hemi (half) acetals, and then the desired acetals:

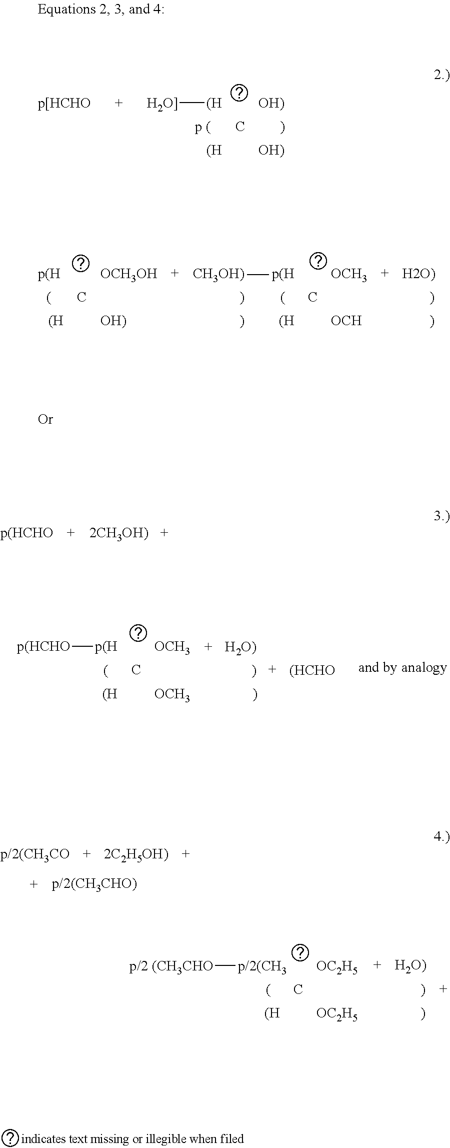

part of the above reaction yields as well mixed acetals as follows:

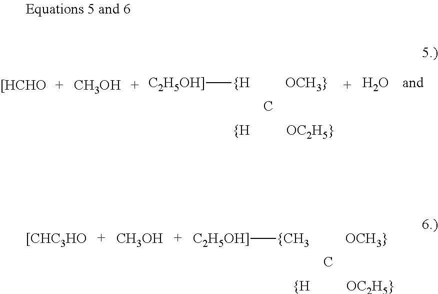

In the above conditions it becomes clear that the general formula of the hemi acetals is:

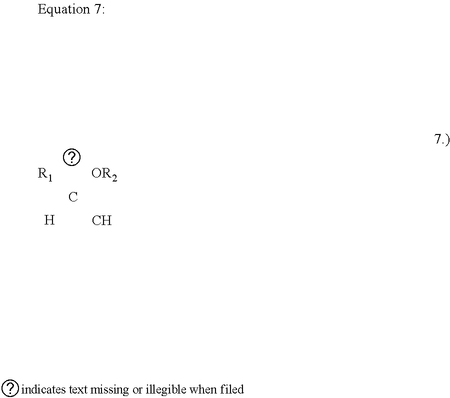

and that the generalized formula of the acetals is:

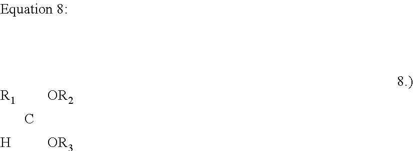

in the above conditions it becomes clear that the general formula for the hemi acetals is expressed by formula 7, while the general formula of the acetals is described by formula 8.

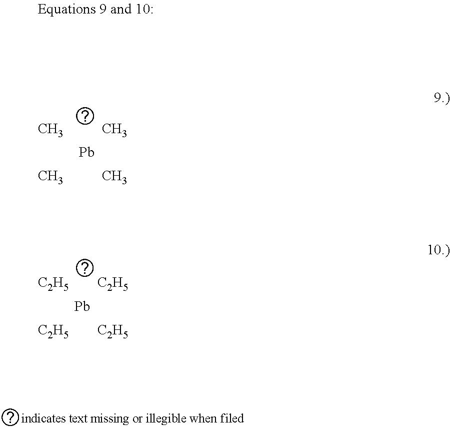

Examining first their structural formulae and properties, the inventor concluded that their high octane number (O.N.) of over 114 is not due to the lead atom, but rather, is due to the existing “4 valences property”, bounding 4 alkyl radicals. By replacing the Pb atom, with another atom, having 4 valences electrons, carbon C was selected for this purpose, in order to attach to it different radicals. This led to the formulae of the hemi acetals and to the acetals. The experimental tests performed first in the United States, then at the Plama Refinery, in Pleven, Bulgaria, indicated that the octane number of any acetal, ranging from an Octane number of 123 to 150.8 surpass those of the alkyl lead compound. Road tests conducted both in the United States and in Bulgaria have shown that they make the best antiknocks, with the exception of hydrogen. The same road test further indicated that when 4% to 8% water is added to the acetal fuels, the water dissolves them, cooling the car's engine internally, through its latent heat of vaporization, thereby yielding up to 15% more mileage. As such, they can be used as an alternative source of fuel for the start-up engine for the bezentropic bladeless turbine, or for thrust.

What is claimed is:

1-18. (canceled)

19. Apparatus for generating mechanical work from a working fluid, the apparatus comprising:
a stator;
a rotor mounted within the stator having at least one working-fluid in-feed opening;
an output shaft that is rotated by the working fluid flowing through the rotor;
a plurality of Archimedean spiral channels mounted within the rotor and wound around the output shaft, each Archimedean spiral channel having a channel opening; and
a CD nozzle for receiving the working fluid, the CD nozzle having converging nozzle inlet and a diverging nozzle exit, the nozzle exit having a shape that corresponds with a shape of the channel opening;
wherein the exit opening of the CD nozzle and the working-fluid in-feed opening are in close proximity to each other and the working fluid is ejected from the nozzle exit as a supersonic, flow having a mono-directional molecular order of the working fluid and injected through the working-fluid in-feed opening on the rotor into the plurality of Archimedean spiral channels;
wherein the CD nozzle and the Archimedean spiral channels together ensure that the mono-directional molecular order of the working fluid is maintained, thereby reducing entropic losses in the working fluid to a minimum.

2. The apparatus of claim 2, wherein the shape of the nozzle exit is flattened.

3. The apparatus of claim 1, wherein the working-fluid in-feed opening on the rotor includes more than one working-fluid in-feed opening.

4. The apparatus of claim 3, wherein the more than one working-fluid in-feed opening includes a first in-feed opening and a second in-feed opening, the two openings spaced 180 degrees apart.

5. The apparatus of claim 1 further comprising an energy booster device that is provided at the nozzle exit, wherein the energy booster device injects preheated steam into the supersonic rectified flow of the working fluid at the nozzle exit.

6. The apparatus of claim 5, wherein the energy booster device has a length that corresponds at least to a length of the flattened shape of the nozzle exit, the length of the energy booster device being perforated with small openings through which the pre-heated steam is forced into the supersonic, rectified flow of the working fluid, and wherein the pre-heated steam spontaneously flashes into saturated steam, thereby increasing a volume of the working fluid as the working fluid enters the rotor.

7. The apparatus of claim 6, wherein the CD nozzle and the energy booster device are constructed as a single component, with the energy booster device mounted at the nozzle exit.

8. The apparatus of claim 1, wherein the stator is cylindrical and the rotor is rotatably mounted within the stator, the rotor having two end disks that extend radially relative a longitudinal axis of the output shaft, and wherein the spiral channels are formed by sheets having two side edges, the sheets wound in a spiral about the output shaft with the two side edges affixed respectively to the end disks, so as to form the Archimedean spiral channels with the channel opening extending parallel to the longitudinal axis of the output shaft.

9. The apparatus of claim 1, wherein the working fluid becomes spent working fluid as it passes through the spiral channels and wherein the spent working fluid is removed from the rotor.

10. The apparatus of claim 1, wherein the working fluid is steam.

11. The apparatus of claim 1, wherein the working fluid is Freon.

12. The apparatus of claim 1, wherein the working fluid is hydrogen.

13. The apparatus of claim 1, wherein the working fluid is wind.

14. A method of generating mechanical work or thrust, the method comprising the steps of:
a) providing a working fluid that has a mono-directional molecular order;
b) providing a rotor having Archimedean spirals;
c) providing an output shaft that is coupled to the rotor; and
d) injecting the working fluid into the Archimedean spirals of the rotor;
wherein the mono-directional molecular order of the working fluid is sustained and maintained throughout a passage of the working fluid through the Archimedean spirals.

15. The method of claim 14, wherein the step of providing a working fluid includes the step of:
a1) providing a steam generator and using steam as the working fluid.

16. The method of claim 14, wherein the step of providing a working fluid includes the step of:
a2) providing a Freon steam boiler and using Freon falls as the working fluid.

17. A method of providing a rectified flow of a working fluid, the method comprising the steps of:
a) forcing the working fluid through a device that creates a molecularly ordered flow;
b) introducing the molecularly ordered flow into Archimedean spiral channels that maintain and sustain the molecularly ordered flow; and
c) applying the working fluid to apparatus for generating mechanical work.
